(19) United States
(12) Patent Application Publication
(10) Pub. No.: US 2021/0126663 A1
(43) Pub. Date: Apr. 29, 2021

(54) MILLIMETER-WAVE UP/DOWN CONVERTER WITH AN INTERNAL SIGNAL SOURCE THEREIN CAPABLE OF MANUAL COARSE TUNING AND FINE TUNING

(71) Applicant: Taiwan Microwave Circuit Co., Ltd, Zhubei City (TW)

(72) Inventors: Miao-Lin HSU, Zhubei City (TW); Tsung-Hsin LIU, Zhubei City (TW); Yi-Ting LIN, Zhubei City (TW); Ting Yuan LEE, Zhubei City (TW)

(21) Appl. No.: 16/662,136

(22) Filed: Oct. 24, 2019

(51) Int. Cl. H04B 1/16; H04L 7/00

(52) U.S. Cl. CPC H04B 1/16; H04L 7/0079

(57) ABSTRACT

the present invention provides a millimeter-wave up/down converter, with an internal signal source therein capable of manual coarse tuning and fine tuning, used for receiving and converting a low frequency/high frequency signal into a high frequency/low frequency signal to be used by a device in a user terminal, and comprises a micro-controller module, an adjusting switch, and a frequency-converter module. The micro-controller module is provided therein with a frequency control signal with a frequency within a frequency range. The adjusting switch is connected to the micro-controller module for adjusting the frequency control signal; thereby the adjusted frequency control signal is outputted from the micro-controller module. The frequency-converter module is connected to the micro-controller module to receive the adjusted frequency control signal, such that after further receiving an external low frequency and high frequency signal, the frequency-converter module generates and outputs the high frequency/low frequency signal.

### FIELD OF THE INVENTION

The present invention relates to a millimeter-wave up/down converter with an internal signal source therein capable of manual coarse tuning and fine tuning and being converted into a high-frequency or a low-frequency signal at any time, which has a simple structure and lower cost, and the frequency can be manually adjusted and is especially suitable for use in a high frequency millimeter wave 5G converter.

### BACKGROUND OF THE INVENTION

With the development of communication technology, with increasing demands for data services, the telecommunication companies have continually researched on wireless systems. Therefore, communication common carriers constantly make research to improve the bandwidth and in higher carrier frequency. For example, fifth-generation wireless systems (5G) will include the use of millimeter-waves (mm-waves) frequency to provide Multi-Gbps data per second, usually in femto, pico, or metro cell type of deployments. Compared with the high frequencies used in conventional wireless systems, such as the 11-300 GHz millimeter waves, the millimeter wave band usually refers to 30 to 300 GHz, and its corresponding wavelength is 1 to 10 mm. Millimeter waves can provide a wider frequency band. With the rapid growth of information volume, the throughput of data transmission will also be increased. It is expected that the throughput of data transmission in the post-4G generation will be increased 1000 times in 2020 and 10,000 times in 2025. Moreover, the transmission technology of the millimeter-wave spectrum segment has been regarded as one of the key communication technologies with high data throughput capability, and this technology plays a pivotal role in the development of the post-4G communication technology and even the 5G communication technology.

However, there are still some technical difficulties in the use of millimeter waves in the conventional wireless communication technology. Basically, the technical problem regarding the use of millimeter waves is that the wave energy might be severely attenuated during propagation, which is highly related to that the operation of the millimeter wave communication system is at high frequency band. Further, compared with the 3G or 4G communication systems commonly used today, millimeter wave communication systems use relatively high frequency bands for communication. It can be known that the value of the energy of the electromagnetic waves received by a receiver is inversely proportional to the square of the signal transmission distance and is proportional to the wavelength of the electromagnetic wave signal. Accordingly, for the millimeter wave communication systems, the attenuation of the signal energy will be greatly increased by using the high-frequency signal with short-wavelength.

It is possible to provide an up-conversion of frequency-signal via the connection with a computer, so as to increase the signal energy, to widen the bandwidth, and to improve the transmission speed. However, for general users, in addition to the inconvenience of the operation via a computer, it is also inconvenient that frequencies cannot be adjusted to an appropriate value. Similarly, if there is a need to transmit the high-frequency signal back to a base station, the conventional method is to provide a down-conversion of frequency-signal via the connection with a computer. In the same way, there is the same technical problem as mentioned above, that is, up-conversion of frequency-signal-needs to be provided by the operation via the computer, and the frequency cannot be adjusted.

### SUMMARY OF THE INVENTION

In view of this, in order to provide a structure different from prior art and to improve the above disadvantages, the inventor has continuously researched to develop the present invention.

The main object of the present invention is to provide a millimeter-wave up/down converter with the frequency of an internal signal source therein capable of manual coarse tuning and fine tuning and be converted into a high-frequency or a low-frequency signal at any time, which has a simple structure and lower cost.

In order to fulfill above object, the present invention provides a millimeter-wave up/down converter with an internal signal source therein capable of manual coarse tuning and fine tuning, used for receiving and converting a low frequency/high frequency signal into a high frequency/low frequency signal to be used by a device in a user terminal, and comprises a micro-controller module, an adjusting switch, and a frequency-converter module. The micro-controller module is provided therein with a frequency control signal with a frequency within a frequency range. The adjusting switch is connected to the micro-controller module for adjusting the frequency control signal; thereby the adjusted frequency control signal is outputted from the micro-controller module. The frequency-converter module is connected to the micro-controller module to receive the adjusted frequency control signal, such that after receiving an additional external low frequency-high frequency signal, the frequency-converter module generates and outputs the high frequency/low frequency signal.

In an implementation, the micro-controller module is further connected with a display module for displaying the value of the adjusted frequency control signal.

In an implementation, the adjusting switch includes a coarse tuning multi-bit controlling switch and a fine-tuning multi-bit controlling switch that are respectively connected to the micro-controller module.

In an implementation, the present invention further includes a signal-synthesizer module for frequency mixing, and the signal-synthesizer module is respectively connected to the micro-controller module and the frequency-converter module.

In an implementation, the signal-synthesizer module is further connected with a clock-generator module for providing a reference clock to the signal-synthesizer module.

In an implementation, after the high frequency/low frequency signal is generated, the value of the high frequency/low frequency signal is detected and displayed on a display module by connecting the frequency-converter module with a signal detection module and the display module.

The present invention will be understood more fully by reference to the detailed description of the drawings and the preferred embodiments below.

### BRIEF DESCRIPTION OF DRAWINGS

FIG. 1 is an architectural diagram of the embodiment of the present invention when the frequency is increased.

FIG. 2 is an architectural diagram of the embodiment of the present invention when the frequency is decreased.

### DETAILED DESCRIPTIONS OF PREFERRED EMBODIMENTS

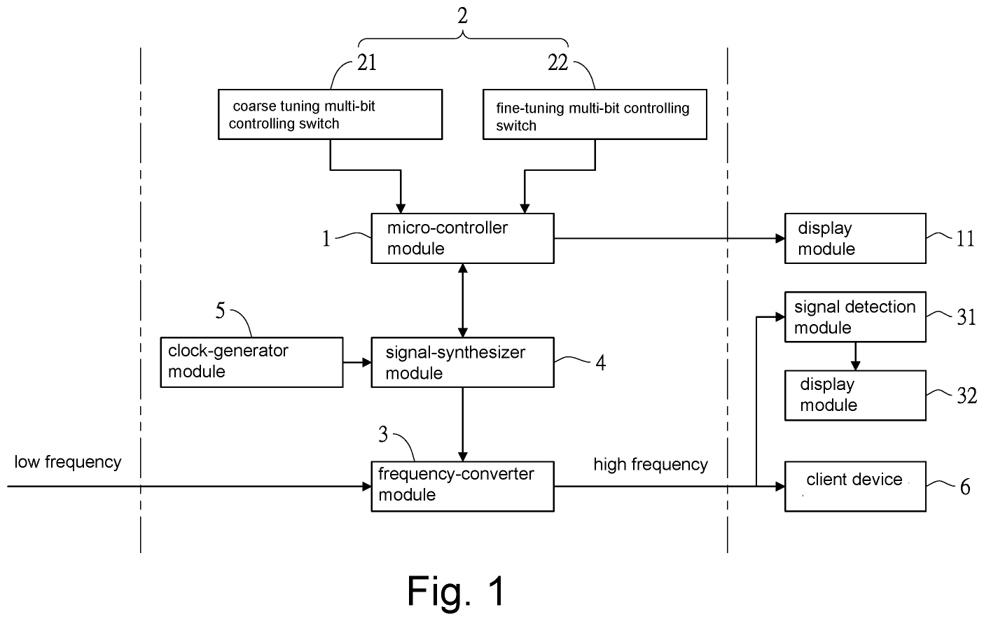

Please refer to FIG. 1, which is an embodiment of a millimeter-wave up/down converter with an internal signal source therein is capable of manual coarse tuning and fine tuning, used for receiving and converting a low frequency/high frequency signal into a high frequency/low frequency signal to be used by a device in a user terminal. The following shows an example of receiving and converting a low frequency signal into a high frequency for being used by a device in a user terminal.

The millimeter-wave up/down converter of the present invention with an internal signal source therein capable of manual coarse tuning and fine tuning, comprises a micro-controller module 1, an adjusting switch 2, and a frequency-converter module 3.

The micro-controller module 1 is provided with a frequency control signal with a frequency within a frequency range.

The adjusting switch 2 is connected to the micro-controller module 1 for adjusting the frequency control signal; thereby the adjusted frequency control signal is outputted from the micro-controller module 1. The adjusting switch 2 includes a coarse tuning multi-bit controlling switch 21 and a fine-tuning multi-bit controlling switch 22 that can be used to adjust the frequency control signal by way of manual coarse tuning and fine tuning. The micro-controller module 1 is further connected with a display module 11 for displaying the value of the adjusted frequency control signal.

The frequency-converter module 3 is connected to the micro-controller module 1 to receive the adjusted frequency control signal, such that after receiving an additional external low frequency 5G signal, the frequency-converter module 3 generates and outputs the high frequency signal. After the frequency-converter module 3 generates the high frequency signal, the value of the high frequency signal is detected and displayed on a display module 32 by connecting the frequency-converter module 3 with a signal detection module 31 and the display module 32.

Moreover, the present invention further comprises a signal-synthesizer module 4 for frequency mixing, and the signal-synthesizer module 4 is respectively connected to the micro-controller module 1 and the frequency-converter module 3. The signal-synthesizer module 4 is further connected with a clock-generator module 5 for providing a reference clock to the signal-synthesizer module 4.

Therefore, in an implementation, after the present invention and a signal input port receive a low frequency 5G signal, a user can manually adjust the adjusting switch 2 to adjust the frequency control signal by way of manually coarse tuning or fine tuning, thereby the adjusted frequency control signal in the micro-controller module 1 can be outputted from the micro-controller module 1, and the value of the adjusted frequency control signal can be displayed by the display module 11, and the low frequency 5G signal is converted by the frequency-converter module 3 to produce a high frequency signal, and the high frequency signal is then outputted to a client device 6, such as an antenna.

Therefore, through the arrangement of the present invention, users can manually adjust the inputted frequency control signal by way of manual coarse turning or fine turning at any time, and a low frequency signal originally received is converted into a high frequency, so as to improve the transmission speed and efficiency.

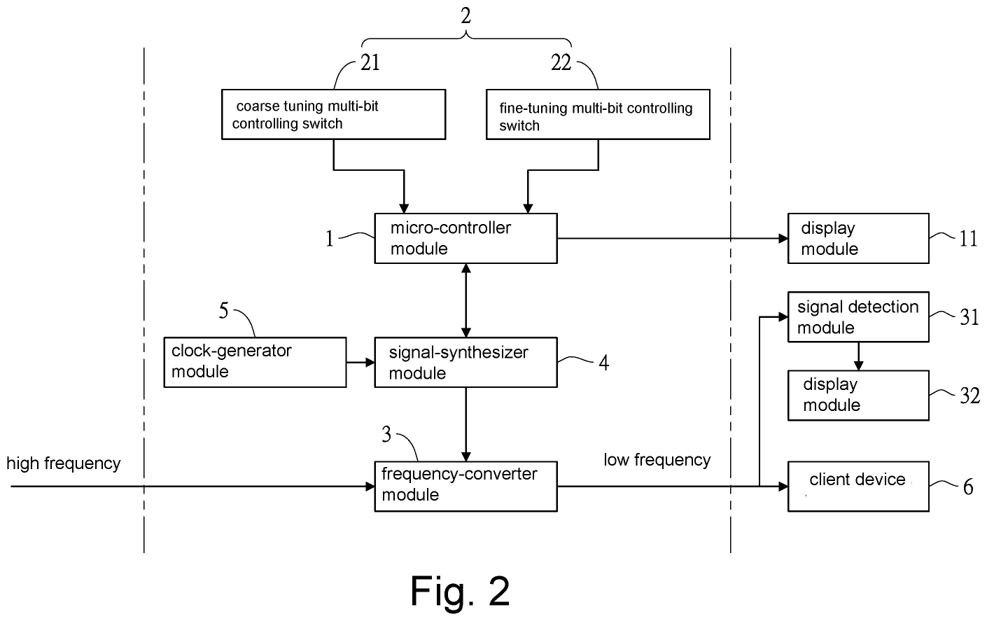

Similarly, when users need to transmit the high frequency signal back to a base station, the users can use the present invention to perform down-conversion, that is, when the signal input port receives the high frequency signal, the users can adjust the adjusting switch 2 capable of manual coarse tuning or fine tuning, so that the frequency control signal in the micro-controller module 1 can be adjusted and outputted from the micro-controller module 1 to form a low-frequency signal and output the low-frequency signal to the base station as shown in FIG. 2.

The description referred to in the drawings and stated above is only for the preferred embodiments of the present invention. Many equivalent variations and modifications can still be made by those skilled in the field of the present invention without departing from the spirit of the present invention, so they should be regarded to fall into the scope defined by the appended claims.

To sum up, the millimeter-wave up/down converter with an internal signal source therein capable of manual coarse tuning and fine tuning provided by the present invention can indeed meet its anticipated object, and can be put into industrial use.

1. A millimeter-wave up/down converter with an internal signal source therein capable of manual coarse tuning and fine tuning, used for receiving and converting a low frequency/high frequency signal into a high frequency/low frequency signal to be used by a device in a user terminal, and comprising:
a micro-controller module, provided therein with a frequency control signal for a frequency within a frequency range;
an adjusting switch, connected to the micro-controller module for adjusting the frequency control signal, thereby the adjusted frequency control signal is outputted from the micro-controller module, wherein the adjusting switch includes a coarse tuning multi-bit controlling switch and a fine-tuning multi-bit controlling switch that are respectively connected to the micro-controller module;
a frequency-converter module, connected to the micro-controller module to receive the adjusted frequency control signal, such that after receiving an additional external low frequency or high frequency signal, the frequency-converter module generates and outputs the high frequency/low frequency signal.

2. The millimeter-wave up/down converter of claim 1, wherein the micro-controller module is further connected with a display module for displaying the value of the adjusted frequency control signal.

3. The millimeter-wave up/down converter of claim 2, wherein the adjusting switch includes a coarse tuning multi-bit controlling switch and a fine-tuning multi-bit controlling switch that are respectively connected to the micro-controller module.

4. The millimeter-wave up/down converter of claim 1, further includes a signal-synthesizer module for frequency mixing, and the signal-synthesizer module is respectively connected to the micro-controller module and the frequency-converter module.

5. The millimeter-wave up/down converter of claim 4, wherein the signal-synthesizer module is further connected with a clock-generator module for providing a reference clock to the signal-synthesizer module.

6. The millimeter-wave up/down converter of claim 1, wherein after the high frequency/low frequency signal is generated, the value of the high frequency/low frequency signal is detected and displayed on a display module by connecting the frequency-converter module with a signal detection module and the display module.

7. (canceled)
